(19) United States
(12) Patent Application Publication
(10) Pub. No.: US 2023/0070492 A1
(43) Pub. Date: Mar. 9, 2023

(54) TECHNIQUES FOR REDUCING CODING ARTIFACTS IN CODING SYSTEM

(71) Applicant: Apple Inc., Cupertino, CA (US)

(72) Inventors: Jiancong Luo, San Diego, CA (US); Dzung T. Hoang, San Jose, CA (US); Francesco Iacopino, Los Gatos, CA (US); Linfeng Guo, Cupertino, CA (US); Mukta S. Gore, Santa Clara, CA (US); Ryan Baldwin, San Jose, CA (US); Supradeep T. Rangarajan, San Jose, CA (US); Xiaohua Yang, San Jose, CA (US)

(21) Appl. No.: 17/886,858

(22) Filed: Aug. 12, 2022

Related U.S. Application Data
(60) Provisional application No. 63/235,553, filed on Aug. 20, 2021.

(51) Int. Cl. H04N 19/154; H04N 19/124; H04N 19/18; H04N 19/176

(52) U.S. Cl. CPC H04N 19/154; H04N 19/124; H04N 19/18; H04N 19/176

(57) ABSTRACT

Techniques for reducing reduce coding artifacts in video data are disclosed. In one aspect, a frame of video data is partitioned into pixel blocks, which are organized into slices. The pixel blocks of each slice are coded by a compression algorithm and an estimate of coding artifacts in the slice is made. For slices that are estimated to possess coding artifacts, the method revises coding parameters applied to pixel blocks in the slice and recodes the slice. The method substitutes recoded slices for originally-coded slices in frame, working in a priority order from a slice with the highest estimated likelihood of coding artifacts down to slices with lower estimated likelihoods of coding artifacts, measuring changes in the frame's coding size as it goes. The likelihood of coding artifacts can be estimated from slice statistics that may be developed from a comparison of transform coefficients among the pixel blocks within a slice, from an evaluation of transform coefficients of a pixel block with a slice that is estimated to have a lowest spatial complexity, or from coded luma data of the pixel blocks within a slice. In a further aspect, slice statistics may be computed from pixel block data only for a subset of slices within a frame. Slice statistics for other slices may be derived from the statistics of neighboring slices. In another aspect, a method may revise coding parameters in iterative fashion working from an initialized value and estimate (without recoding them) data sizes of coded slices that may be obtained from the revised parameters. As the method operates, it may compare the coding parameters to parameters used in a first iteration of coding and terminate the iterative process for that slice if the first iteration coding parameters are higher than the revised parameter.

### CLAIM FOR PRIORITY

This application claims benefit of priority conferred by application Ser. No. 63/235,553, filed Aug. 20, 2021, entitled “Techniques for Reducing Coding Artifacts In Coding System,” the disclosure of which is incorporated herein in its entirety.

### BACKGROUND

The present disclosure relates to techniques for video coding and, more particularly, to techniques for reducing coding artifacts that may arise from video compression.

Streaming media delivery is used in a variety of commercial and consumer applications. Media often includes video and audio streams that are delivered across computer networks from a media sender to a media consumer. In its native form, these video and audio streams are formatted for use by video and audio devices. Media devices often exploit redundancies in video and audio data to compress the data into a smaller data representation for delivery across the computer network(s).

Video coding often involves exploiting spatial and/or temporal redundancies in video content. For example, frames of video data often are represented by pixels that represent image content spatially. A frame's pixel-domain representation may be transformed into other representations such as frequency-based representations by transforms such as the discrete cosine transform. Transform coefficients obtained from this process may be quantized by quantization parameters and entropy-coded to achieve high compression.

The performance of this compression process can be difficult to predict. Quantization typically divides coefficient values by quantization parameters. Quantization can induce information losses because some non-zero coefficients are reduced to zero. When the quantization process is inverted, these non-zero coefficients are not recovered. Thus, recovered video will be, at best, a replica of the source video that it represents. And different kinds of coding losses are perceived as significant to human viewers whereas other kinds of losses are not considered significant.

The compression ratios achieved by entropy coding vary based on the number of zero valued coefficients that are generated by the quantization process. Seemingly small variations in quantization parameters can have large effects on these compression ratios. Moreover, the relationships between a quantization parameter selection, the coding losses that it incurs, and the compression ratio that it achieves cannot always be predicted in advance. Additionally, it can be disadvantageous simply to code video data with all permutations of quantization parameters because doing so wastes computational resources in a processing device.

### BRIEF DESCRIPTION OF THE DRAWINGS

FIG. 1 is a simplified block diagram of a video distribution system according to an aspect of the disclosure.

FIG. 2 is a functional block diagram of a video coder according to an aspect of the present disclosure.

FIG. 3 illustrates an exemplary frame partitioned into slices and pixel blocks suitable for use with aspects of the present disclosure.

FIG. 4 illustrates a method according to an aspect of the disclosure.

FIG. 5 illustrates exemplary pixel blocks suitable for use with aspects of the present disclosure

FIG. 6 illustrates a method according to another aspect of the disclosure.

FIG. 7 illustrates an exemplary frame partitioned into slices and pixel blocks suitable for use with aspects of the present disclosure.

### DETAILED DESCRIPTION

Embodiments of the present invention provide techniques to reduce coding artifacts in video data in video coding applications. According to a method in one aspect, a frame of video data is partitioned into pixel blocks, which are organized into slices. The pixel blocks of each slice are coded by a compression algorithm and an estimate of coding artifacts in the slice is made. For slices that are estimated to possess coding artifacts, the method revises coding parameters applied to pixel blocks in the slice and recodes the slice. The method substitutes recoded slices for originally-coded slices in frame, working in a priority order from a slice with the highest estimated likelihood of coding artifacts down to slices with lower estimated likelihoods of coding artifacts, measuring changes in the frame's coding size as it goes. If a substitution would cause the frame's coding size to exceed a size limit, the slice substitution process terminates. Originally-coded slices for any lower priority slice would remain in the coded frame. This method generates a coded frame that meets its size limit and “repairs” the slices with the highest likelihood of coding artifacts.

In another aspect, the likelihood of coding artifacts can be estimated slice statistics that are developed from evaluation of data of coded pixel blocks. For example, the slice statistics may be developed from a comparison of transform coefficients among the pixel blocks within a slice, from an evaluation of transform coefficients of a pixel block with a slice that is estimated to have a lowest spatial complexity, or from coded luma data of the pixel blocks within a slice.

In a further aspect, slice statistics may be computed from pixel block data only for a subset of slices within a frame. Slice statistics for other slices may be derived from the statistics of neighboring slices.

In another aspect, a method may revise coding parameters in iterative fashion working from an initialized value and estimate (without recoding them) data sizes of coded slices that may be obtained from the revised parameters. As the method operates, it may compare the coding parameters to parameters used in a first iteration of coding and terminate the iterative process for that slice if the first iteration coding parameters are higher than the revised parameter.

FIG. 1 is a simplified block diagram of a video distribution system 100 according to an aspect of the disclosure. The system 100 may include a coding terminal 110 and a decoding terminal 120 provided in mutual communication by one or more communication networks 130.

The source terminal 110 may supply a stream of coded video 140 to the network 130, which may deliver the coded video 140 to the decoding terminal 120. The coded video 140 may be coded according to a compression protocol that reduces its data size as compared to the video's content when it is displayed. The decoding terminal 120 may decode the coded video 140 by inverting coding operations applied by the coding terminal 110, which generates video data that may be displayed or otherwise consumed by the decoding terminal 120.

As discussed, FIG. 1 is a simplified diagram of a video distribution system 100. Such systems, in practice, may have other components than those illustrated in FIG. 1. For example, many video distribution systems employ distribution servers, even distribution networks (not shown), that store coded video for later delivery to decoding terminals 120. In such implementations, a decoding terminal 120 may issue request(s) for coded video according to a communication protocol such as HTTP (HyperText Transfer Protocol), which may be satisfied by a distribution server. The coded video may be packaged and stored as incremental units, often called “segments,” which may be requested by decoding terminals 120 on an as needed basis. The principles of the present disclosure find application with such video distribution systems 100.

FIG. 1 illustrates a video distribution application in which coded video is transmitted in a single direction from a coding terminal 110 to a second terminal 120. The principles of the present disclosure find application with more complicated video distribution topologies. In one aspect, for example, the terminals 110, 120 may exchange coded video bidirectionally in which each terminal 110, 120 generates coded video and supplies it to the network 130 for delivery to the other terminal 120, 110 (bidirectional communication not shown). In this aspect, each terminal 120, 110 may receive coded video from the network 130 and decodes its coded video to generate recovered video. In another aspect, a single coding terminal 110 may multicast coded video to a plurality of decoding terminals (not shown). In such applications, each of the decoding terminals may decode their received copies of coded video to generate recovered video. The principles of the present disclosure also find application with such video distribution systems 100.

In FIG. 1, the terminals 110, 120 are illustrated as a server and a smart display but the principles of the present invention are not so limited. Embodiments of the present invention find application with personal computers (both desktop and laptop computers), tablet computers, handheld computing devices, computer servers, media players and/or dedicated video conferencing equipment. For the purposes of the present discussion, the type of terminal device is immaterial to the operation of the present invention unless explained herein below.

The network 130 represents any number of networks that convey coded video data between the terminals 110, 120, including, for example, wireline and/or wireless communication networks. The communication network 130 may exchange data in circuit-switched or packet-switched channels. Representative networks include telecommunications networks, local area networks, wide area networks and/or the Internet. For the purposes of the present discussion, the architecture and topology of the network 130 are immaterial to the operation of the present invention unless explained herein below.

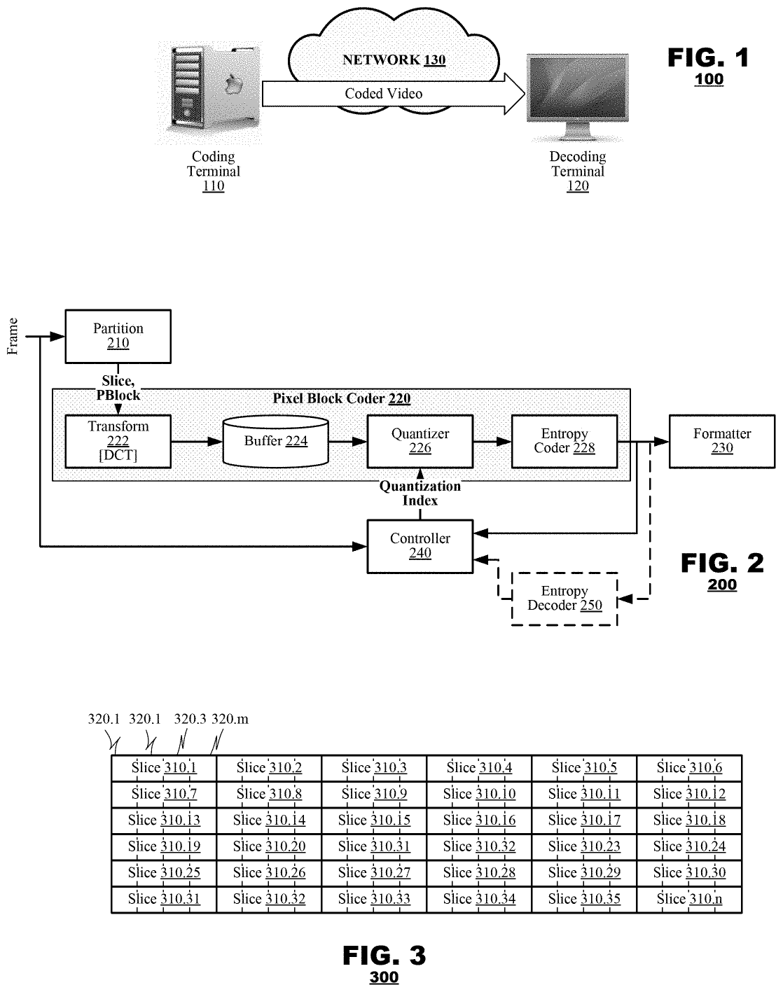

FIG. 2 is a functional block diagram of a video coder 200 according to an aspect of the present disclosure. The video coder 200 may include a partitioning unit 210, a pixel block coder 220, a formatter 230, and a controller 240.

The partitioning unit 210 may partition an input video frame to be coded into pixel blocks, regular arrays of frame content, to be processed by the pixel block coder 220. The pixel block coder 220 may perform coding operations on pixel blocks input from the partitioner 210 to achieve compression. The formatter 230 may format coded video data according to a coding protocol, which may be output from the video coder 200 as coded video. The video coder 200 may find application as, for example, the coding terminal 110 of FIG. 1.

As discussed herein, the partitioning unit 210 may parse frame data into pixel blocks. FIG. 3 illustrates an exemplary frame 300 that may be so partitioned. FIG. 3 illustrates the frame as being partitioned into slices 310.1-310.n and further into pixel blocks 320.1-320.m. As illustrated, an individual slice (say, slice 310.1) may contain a plurality of pixel blocks 320.1-320.m. The pixel blocks, for example, may be 8×8 or 16×16 arrays of frame content. The pixel block coder 220 may code the pixel blocks 320.1-320.m in a pipelined fashion.

The pixel block coder 220 may include a transform unit 222, a quantizer 226 and an entropy coder 228. The transform unit 222 may convert data of a pixel block from a pixel domain to a transform domain by applying a transformer that exploits frequency components of the pixel block data. Common transforms include the discrete cosine transform (commonly “DCT”), a discrete sine transform (“DST”), a Walsh-Hadamard transform, a Haar transform, a Daubechies wavelet transform, or the like. The transform unit 222 may output a matrix of transform coefficients at a same size as the pixel block of pixel values that are input to the pixel block coder (e.g., an 8×8 or 16×16 array of pixel data may generate a corresponding 8×8 or 16×16 array of transform coefficients).

The quantizer 226 may apply quantization to the transform coefficients output by the transform unit 222. The quantizer 226 may operate according to a quantization index that determines the quantization values that are applied to individual transform coefficients. When a coefficient is quantized, its magnitude is divided by a quantization parameter that is determined from the quantization index. In some cases, quantization causes individual transform coefficients to be reduced to zero.

The entropy coder 228, as its name implies, may perform entropy coding of data output from the quantizer 226. For example, the entropy coder 228 may perform run length coding, Huffman coding, Golomb coding, Context Adaptive Binary Arithmetic Coding, and the like.

The formatter 230 may generate a coded video stream from the coded pixel block data output by the pixel block coder 220. For example, the coded pixel block data may be formatted according to the syntax of a governing coding protocol and output to a channel. Formatting may include generating syntax elements for each video frame, generating syntax elements of each slice, and generating syntax elements of each pixel block. These syntax elements typically include a header field that distinguishes the syntax elements from each other and metadata associated with the respective syntax element. The syntax elements typically reflect a hierarchy among the elements. For example, as illustrated in FIG. 3, a frame may include multiple slices 310.1-310.n, and a slice 310.1 may include multiple pixel blocks 320.1-320.m. The syntax elements may contain information that identify to a decoding terminal 120 (FIG. 1) relationships among the frames, the slices, and the pixel blocks. In an aspect, a slice's metadata may include information that is common to all pixel blocks contained within the slice, such as the quantization index.

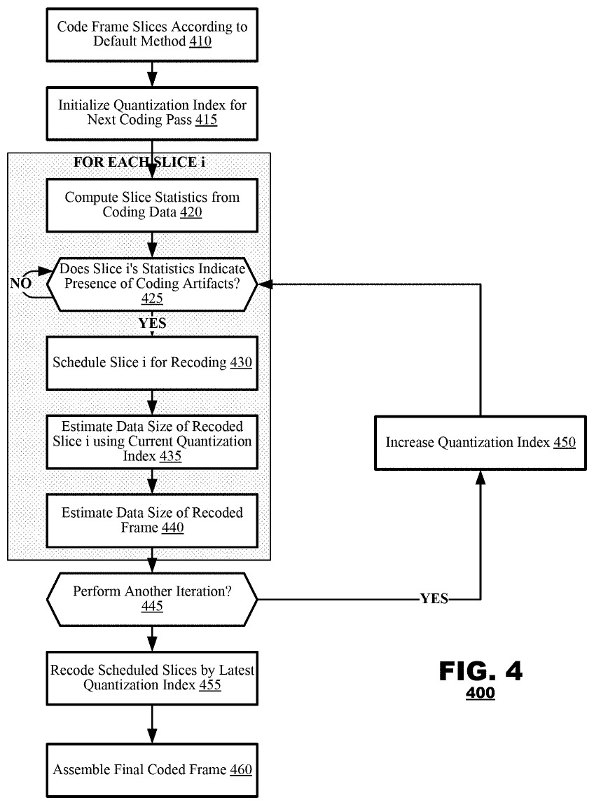

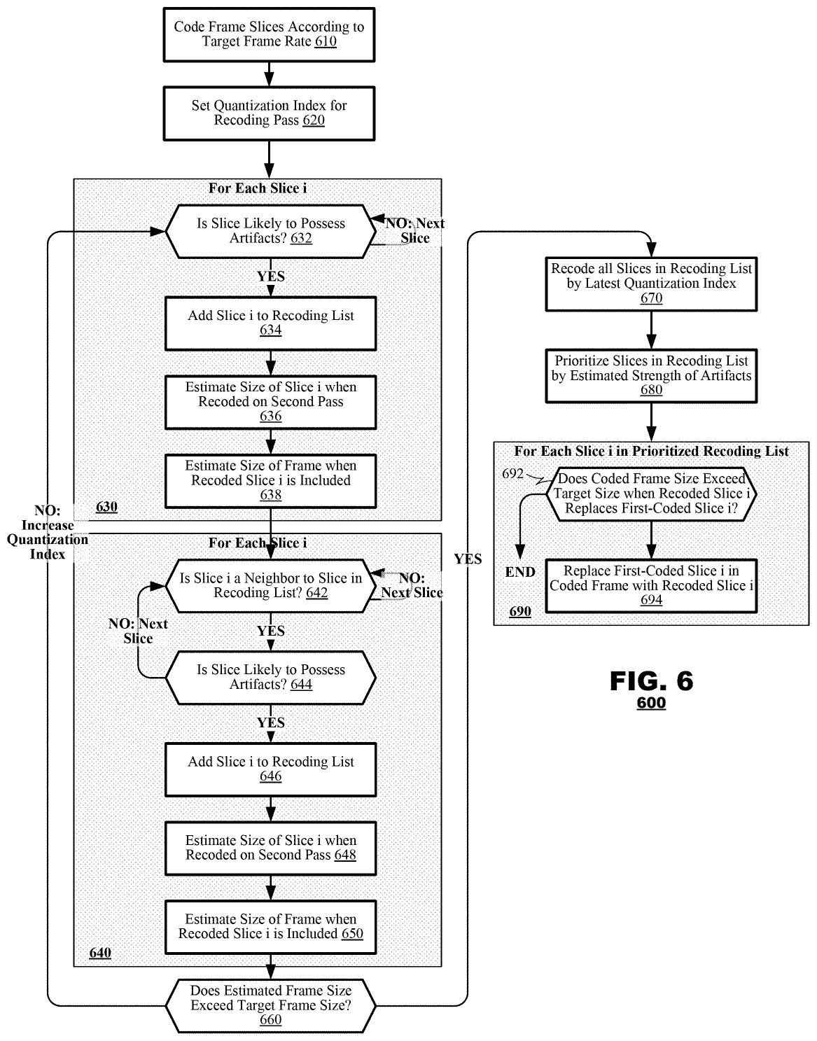

The controller 240 may control operation of the coder 200. Specifically, the controller 240 may set the quantization index for the quantizer 226 as described in FIGS. 4 and 6 herein. As described, the coder 200 may perform video coding in multiple passes. Although the quantization indices may change between the passes, the output of the transform unit 222 need not change and, therefore, the pixel block coder 220 is shown as including a buffer memory 224 to store output of the transform unit 222 for use in a subsequent pass of coding.

In certain aspects of the disclosure discussed herein, the controller 240 may reference decoded video obtained by inverting operations of the entropy decoder 228. FIG. 2 illustrates an entropy decoder 250 for such purposes.

FIG. 4 illustrates a method 400, which may be performed by a controller 240 (FIG. 2), according to an aspect of the disclosure. The method 400 may begin by coding a frame according to a default method (box 410). Typically, the default method may involve selecting a first quantization index (Q₁), for each slice, according to an analysis of frame content and an estimate of the quantization index that will generate a coded slice that, when assembled into a coded frame with other coded slices, meets a frame size limit (F) of the frame when coded. In an aspect, the method 400 may select the slices' first quantization index to meet the target frame size reduced by a value representing a reservation parameter P (e.g., (1−P)*F). The reservation parameter P may define a predicted buffer amount that the method 400 may utilize to recode slices as needed. In an aspect, the reservation parameter may be set to 10-15%.

After the first pass coding (box 410), the method 400 may identify slices to be recoded and select a new quantization index for them. First, the method 400 may initialize a quantization index (Q₂) to be used for recoding slices (box 415). Thereafter, the method may estimate which slices are likely to exhibit coding artifacts. The method 400 may do so by computing, for each slice, slice statistics from the coded data generated in box 410 (box 420). The method 400 may determine, from the statistics, whether coding artifacts are likely to be present in the slice (box 425). If the method 400 determines that coding artifacts are likely to be present, the method may schedule the slice for recoding (box 430). The method 400 may estimate the size of the slice that will be created if the slice were coded using the current quantization index Q₂ (box 435). The method 400 also may estimate the data size of the coded frame that will be created if the current slice were recoded according to the current quantization index (the data obtained in box 435) with reference to the coded slices obtained in box 410 and in other iterations of boxes 420-440.

Once the method 400 completes processing of all slices according to boxes 420-440, the method 400 may determine whether to perform another iteration of boxes 420-440 with an increased quantization index (box 445). In an aspect, the method 400 may determine not to perform another iteration if it determines that the frame size obtained in box 440 is smaller than a size limit (F) assigned to the frame. In another aspect, the method 400 may determine not to perform another iteration if it determines that the current quantization index (Q₂) exceeds a predetermined threshold. Alternatively, the method 400 may determine not to perform another iteration if it determines that the current quantization index (Q₂) exceeds a slice's quantization index value (Q₁) applied at box 410 by more than a threshold amount. When the method 400 determines that it will perform another iteration, it may increase the quantization index (box 450), reset the schedule of slices for recoding, and return to box 425.

When the method 400 determines that it will not perform another iteration, it may recode the scheduled slices using the quantization index (Q₂) most recently developed in box 450 (box 455). Thereafter, the method 400 may assemble the final coded frame (box 460) from the recoded slices obtained in box 455 and any slices obtained in box 410 that were not scheduled for recoding in boxes 420-440.

In an aspect, the method 400 may substitute recoded slices for their originally-coded counterparts on an individualized basis in order, testing changes in coded frame size as it goes. The substitution may occur on a prioritized basis, starting with the slice whose statistics (boxes 420-425) indicate most strongly a likelihood that coding artifacts will be present and ending with the slice whose statistics indicate the lowest likelihood that coding artifacts will be present. In this manner, if the substitution of a recoded frame causes a frame size limit to be exceeded, the substitution may be canceled at that point and the originally-coded slices that have not yet been substituted by recoded slices may be utilized in the final coded frame. This technique may cause the coded frame to have a size that most-closely matches the frame's size limit and also causes slice(s) with the highest likelihood of possessing artifacts to be “repaired” by the method 400.

Slice statistics and estimations of likelihood of coding artifacts (boxes 420-425) may be obtained in a variety of ways. In one aspect, they may be obtained from an analysis of entropy-coded data (output from unit 228 (FIG. 2)) or entropy-decoded data (output from unit 250 (FIG. 2)).

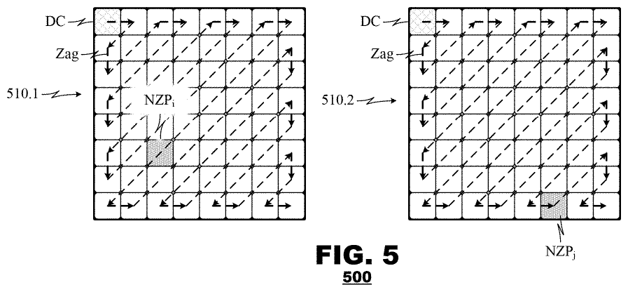

For example, the method 400 may determine the positions of the last non-zero coefficient position from each processed pixel block within a slice, as represented in FIG. 5. FIG. 5 illustrates two exemplary pixel blocks 510.1, 510.2 in the quantized coefficient domain, which are suitable for entropy coding by run length coding. As illustrated, each pixel block may have a matrix position that represents a DC coefficient of the pixel block, and other matrix positions that represent AC coefficients of different frequencies. Also as illustrated, the coefficient matrix may be converted to a stream of serial coefficient values by scanning the matrix according to a zig-zag pattern (represented by ZAG) during entropy coding 228 (FIG. 2). Typically, as the scan advances along the zig-zag pattern ZAG, the scan encounters coefficient positions corresponding to increasingly higher frequency components, which oftentimes have values that are truncated to zero due to quantization 226 (FIG. 2). In an aspect, the method 400 may identify the last non-zero AC coefficient position NZPi, NZPj of each of the pixel blocks 510, 520. In an aspect, a slice's artifact likelihood score may be determined from a difference between the maximum NZP values and the minimum NZP values, e.g. by:

score=max(NZPᵢ)−min(NZPⱼ),

for all i,j in a slice. When a slice has a score larger than an associated threshold (scoreth), it may be identified as likely to have coding artifacts.

In another aspect, a slice may be identified as likely to have coding artifacts based on a value of a DC coefficient (called DC_{flat}, for convenience) of a pixel block having the smallest NZP value of all pixel blocks in the slice. A pixel block having a relatively small NZP value compared to other pixel blocks will have lower spatial complexity, and visual artifacts may be more pronounced in such pixel blocks when they have relatively high brightness. In an aspect, if a slice has multiple pixel blocks with the same NZP value, then DC_{flat} may be set as the maximum DC coefficient value from among the multiple pixel blocks. When a slice's DC_{flat} value is larger than an associated threshold (DC_{flat_th}), it may be identified as likely to have coding artifacts.

In a further aspect, a slice may be identified as likely to have coding artifacts based on a the smallest NZP value (NZPₘᵢₙ) of all pixel blocks in that slice. As discussed, a pixel block having a relatively small NZP value compared to other pixel blocks will have lower spatial complexity, and visual artifacts will be more pronounced in pixel blocks with lower spatial complexity than in other pixel blocks. When a slice's NZPₘᵢₙ value is smaller than an associated threshold (NZP_{min_th}), it may be identified as likely to have coding artifacts.

In another aspect, slice statistics may be developed from a coding size of a luma component of frame video and from the quantization index applied during initial coding. In some coding applications, a partitioning unit 210 may partition an input frame into color planes, for example, luma and chrominance, and further partition the planes into slices and pixel blocks. In such applications, the pixel block coder 220 may operate on color plane representations of the pixel blocks. Moreover, the coded size of luma data and the quantization index may be represented in a slice header in a coding protocol. Developing slice statistics from coding sizes of luma components may permit a method 400 to make recoding selections without decoding coefficient data and, therefore, can conserve processing resources in a controller 240 (FIG. 2).

FIG. 6 illustrates a method 600, which may be performed by a controller 240 (FIG. 2), according to another aspect of the disclosure. The method 600 may begin by coding a frame according to a default method (box 610). In an aspect, the method 600 may select a first quantization index to meet the target frame size reduced by a value representing a reservation parameter P (e.g., (1−P)*F). The reservation parameter P may define a buffer amount that the method 600 may utilize to recode slices as needed. In an aspect, the reservation parameter may be set to 10-15%.

After the first pass coding (box 610), the method 600 may identify slices to be recoded and select a quantization index for them. First, the method 600 may initialize a quantization index to be used for recoding slices (box 620). Thereafter, the method may estimate which slices are likely to exhibit coding artifacts. The method 600 may do so by a multi-tiered analysis strategy.

FIG. 6 illustrates a first tier of analysis 630, represented by boxes 632-638, which may be performed over multiple slices in a frame. The method 600 may determine, from the slice's statistics, whether coding artifacts are likely to be present in the slice (box 632); slice statistics such as those described in paragraphs [37]-[41] may be used. If the method 600 determines that coding artifacts are likely to be present, the method may add the slice to a “recoding list” (box 634), which initially is set to a null value. The method 600 may estimate the size of the slice that will be created if the slice were coded using the current quantization index (box 636). The method 600 also may estimate the data size of the coded frame that will be created if the current slice were recoded according to the current quantization index (the data obtained in box 636) with reference to the coded slices obtained in box 610 (box 638).

FIG. 6 illustrates a second tier of analysis 640, represented by boxes 642-650, which may be performed over multiple slices in a frame. For each slice under analysis, the method 600 may determine whether the slice is a neighbor to another slice that previously was added to the recoding list (box 642). If not, then the slice need not be analyzed further. If so, then the method 600 may determine, from the slice's statistics, whether coding artifacts are likely to be present in the slice (box 644)); slice statistics such as those described in paragraphs [37]-[41] may be used. If the method 600 determines that coding artifacts are likely to be present, the method may add the slice to the recoding list (box 644). The method 600 may estimate the size of the slice that will be created if the slice were coded using the current quantization index (box 646). The method 600 also may estimate the data size of the coded frame that will be created if the current slice were recoded according to the current quantization index with reference to the coded slices obtained in box 610 (box 650).

In an aspect, different criteria may be used during operation of the different tiers 630, 640 to determine whether a slice is likely to possess coding artifacts (boxes 632, 644). Table 1 illustrates exemplary criteria in a two-tier analysis strategy:

TABLE 1

| | |
|---|---|
| Tier 1 | A slice would be determined to be likely to possess coding |
| (630) | artifacts (box 632) if: |
| | The score value is larger than a threshold A1; |
| | NZPmin is smaller than a threshold B; |
| | DCflat is larger than a threshold C1; and |
| | Q1 is larger than Q2. |
| Tier 2 | A slice would be determined to be likely to possess coding |
| (640) | artifacts (box 644) if: |
| | The score value is larger than a threshold A2; |
| | DCflat is larger than a threshold C2; and |
| | Q1 is larger than Q2. |

In the foregoing example, Q1 may be the quantization index selected to code the slice in box 610 and Q2 may be the quantization index used when performing the tier analyses 630 and 640. In an aspect, A1 may be set to be larger than A2, and C1 may be set to be larger than C2. In one aspect, A1 maybe four times larger than A2, and C1 may be four times larger than C2. In this example, a slice that does not meet the criteria of tier 630 might satisfy the criteria of tier 640.

Although not illustrated in FIG. 6, the method 600 may perform other tiers of analysis beyond those represented in tiers 630 and 640. For example, the method 600 perform a third tier of analysis (not shown) that operates similarly to tier 640. In this aspect, the third tier may have different criteria to determine whether a slice is likely to possess coding artifacts. For example, with reference to Table 1, criteria for a third tier may be applied as follows:

TABLE 2

| | |
|---|---|
| Tier 3 (not | A slice would be determined to be likely to possess |
| shown in | coding artifacts if: |
| FIG. 6) | Q1 is larger than Q2. |

Here, again, in this example, a slice that does not meet the criteria of tiers 630 or 640 might satisfy the criteria of this third tier.

Once the method 600 completes processing of all slices according to boxes 620-660, the method 600 may determine whether to perform another iteration the tier analysis 630, 640 with an increased quantization index (box 660). In an aspect, the method 600 may determine not to perform another iteration if it determines that the frame size obtained from the tier analyses 630, 640 is smaller than a size limit (F) assigned to the frame. In another aspect, the method 600 may determine not to perform another iteration if it determines that the current quantization index exceeds a predetermined threshold. Alternatively, the method 600 may determine not to perform another iteration if it determines that the current quantization index exceeds a quantization index value applied at box 610 by more than a threshold amount. When the method 600 determines that it will perform another iteration, it may increase the quantization index 650, reset the recoding list, and return to tier 630.

When the method 600 determines that it will not perform another iteration, it may recode the scheduled slices using the most recently developed quantization index (box 670). Thereafter, the method 600 may assemble a final coded frame from the recoded slices and from any slices obtained in box 610. In an aspect, the method 600 may sort slices in the recoding list for prioritization. The sorting may sort first by the tier 630, 640 in which each slice was added to the recoding list (e.g., slices added during operation of tier 630 may be given higher priority over slices added during operation of tier 640). Sorting within each tier may be performed according to other statistics, for example, by the slices' respective score values.

Thereafter, the method 600 may consider each slice in order from highest priority to lowest priority to assemble a final coded frame (box 690). For each slice in the prioritized recoding list, the method 600 may determine whether the frame's coded size exceeds its size limit if the recorded slice replaced its originally-coded counterpart (box 692). If not, then the originally-coded slice may be replaced in the coded frame with the recoded version of the same slice (box 694) and the method 600 may advance to the next slice. If, at box 692, the method 600 determines that the frame's size limit would be exceeded by replacing the originally-coded slice with the recoded version of the same slice, the method 600 may conclude. For all remaining slices to be consider in box 690, the method 600 may use the originally-coded slices in the final coded frame.

In one implementation, the method 600 may be performed by the following pseudocode:

TABLE 3

| Initialize: | P, the reservation ratio, takes a value between 0 and 1. | |
|---|---|---|
| | (ex.: 0.125) | |
| Step 0 | Encode a frame with bitrate reduced by P. | |
| Step 1 | For each slice in a frame, collect the following data: | |
| | NZPmin: | The minimum of the last non-zero AC coefficient |
| | | position among all 8 × 8 blocks in a slice. |
| | NZPmax: | The maximum of the last non-zero AC coefficient |
| | | position among all 8 × 8 blocks in a slice. |
| | DCflat: | The dequantized DC coefficient of the 8 × 8 |
| | | block with the minimum last non-zero AC |
| | | coefficient position. |
| | Score: | The difference between minimum and maximum of |
| | | the last non-zero AC coefficient position, |
| | | NZPmax − NZPmin. |
| Step 2 | Develop algorithm parameters: | |
| | List L: | Denotes a list containing slices having |
| | | artifacts and need to be fixed. Clear list L. |
| | Q: | Denotes the 2nd pass quantization index. Initialize |
| | | Q2 to be a constant QL (6). |
| | F1: | Denotes the 1st pass coded frame size, |
| | F2: | Denotes the 2nd pass estimated coded frame size. |
| | Initialize F2 to be F1. | |
| Step 3 | For each slice in a frame, do the following: | |
| | If all of the following conditions are true, | |
| | a. | score is larger than a threshold A1 (32) |
| | b. | NZPmin is smaller than a threshold B (8) |
| | c. | DCflat is larger than a threshold C1 (128) |
| | d. | Q1 is larger than Q2 |
| | then execute the following steps: | |
| | 1. | add the slice to list L |
| | 2. | Let S1 denote the 1st pass coded slice size, S2 |
| | | denote the estimated the 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list L by the score in descending | |
| | order | |
| Step 4 | For each slice in a frame, do the following: | |
| | If all of the following conditions are true, | |
| | a. | slice is not in list L |
| | b. | score is larger than a threshold A2 (8) |
| | c. | DCflat is larger than a threshold C2 (32) |
| | d. | at least one of the four neighboring slices |
| | | (above, below, left and right) is in list L |
| | e. | Q1 is larger than Q2 |
| | then execute the following steps: | |
| | 1. | add the slice to a temporary list X |
| | 2. | Let S1 denote the 1st pass coded slice size, S2 |
| | | denote the estimated 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list X by score in descending order | |
| | and append list X to list L and clear X. | |
| Step 5 | For each slice in a frame, do the following: | |
| | If all of the following conditions are true, | |
| | a. | slice is not in list L |
| | b. | at least one of the slices above or below is in |
| | | list L |
| | c. | Q1 is larger than Q2 |
| | then execute the following steps: | |
| | 1. | add the slice to a temporary list X |
| | 2. | Let S1 denote the 1st pass coded slice size, S2 |
| | | denote the estimated 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list X by score in descending order | |
| | and append list X to list L and clear X | |
| Step 6 | If Q2 is smaller than a threshold M (9), then update P by: | |
| | | P = MIN(0, MAX(T3, 1 − F1/F2), where T3 is set to |
| | | 0.3125 |
| Step 7 | If one of the following conditions is true: | |
| | F2 is smaller than target frame size | |
| | Q2 is larger than a threshold T2 (16) | |
| | Go to step 8. | |
| | Otherwise increase Q2 by 1 and jump to step 3 | |
| Step 8 | Encode all slices in list L with quantization index Q2 | |
| Step 9 | Let R denote a slice to be replace. Initialize R to be | |
| | the first element in list L. | |
| | Initialize F2 to F1. | |
| Step 10 | Let CF denote the 1st pass compressed frame. Let S1 and | |
| | S2 denote the 1st pass and 2nd pass coded slice size of | |
| | slice R, respectively. If F2 − S1 + S2 < target frame | |
| | size, then do the following. | |
| | a. | Replace slice R in CF with the 2nd pass coded slice |
| | b. | Update F2 = F2 − S1 + S2 |
| | c. | Set R to be the next element in list L |
| | d. | Jump to step 10 |
| | Otherwise, do the following, | |
| | a. | Output CF as the final compressed frame |
| | b. | Start next frame from step 0 |

As shown above, this aspect utilizes the score, DC_{flat}, and NZPₘᵢₙ slice statistics discussed above.

In another implementation, the method 600 may be performed by the following pseudocode:

TABLE 4

| Initialize: | P, the reservation ratio, takes a value between 0 and 1. | |
|---|---|---|
| | (ex.: 0.125) | |
| Step 0 | Encode a frame with bitrate reduced by P. | |
| Step 1 | For each slice in a frame, collect the following data: | |
| | CPLX: | Denotes the complexity of a slice. |
| | Calculate CPLX by: | |
| | | CPLX = coded size of Luma data * Q1 \hat{ } 0.6 |
| Step 2 | Develop algorithm parameters: | |
| | List L: | Denotes a list containing slices having |
| | | artifacts and need to be fixed. Clear list L. |
| | Q: | Denotes the 2nd pass quantization index. |
| | | Initialize Q2 to be a constant QL (6). |
| | F1: | Denotes the 1st pass coded frame size, |
| | F2: | Denotes the 2nd pass estimated coded frame size. |
| | Initialize F2 to be F1. | |
| Step 3: | For each slice with Q1 larger than Q2, do the following: | |
| | If any of the following conditions are true, | |
| | a. | CPLX of current slice is smaller than a threshold |
| | | (2000) |
| | b. | CPLX of current slice is smaller than a threshold |
| | | (4000) and CPLX of any of the 4 neighbors is |
| | | smaller than a threshold (400) |
| | then execute the following steps: | |
| | 1. | add the slice to list L |
| | 2. | Let S1 denote the 1st pass coded slice size, S2 |
| | | denote the estimated 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list L by score in descending order | |
| Step 4: | For each slice in a frame, do the following: | |
| | If all of the following conditions are true, | |
| | a. | slice is not in list L |
| | b. | Q1 is larger than Q2 |
| | c. | CPLX is smaller than a threshold (5000) |
| | d. | at least one of the slices above or below is in |
| | | list L |
| | then execute the following steps: | |
| | 1. | create a temporary list X and add the slice to X |
| | 2. | Let S1 denote the 1st pass coded slice size, S2 |
| | | denote the estimated 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list X by score in descending order | |
| | and append list X to list L and clear X | |
| Step 5 | For each slice in a frame, do the following: | |
| | If all of the following conditions are true, | |
| | a. | slice is not in list L |
| | b. | at least one of the slices above or below is in |
| | | list L |
| | c. | Q1 is larger than Q2 |
| | then execute the following steps: | |
| | 1. | add the slice to a temporary list X |
| | 2. | Let S1 denote the 1st pass coded slice size, S2 |
| | | denote the estimated 2nd pass coded slice size |
| | | and Q1 denote the 1st pass quantization index. |
| | | Calculate S2 by |
| | | S2 = (S1 − 6) * Q1 \hat{ } 0.6/Q2 \hat{ } 0.6 + 6. |
| | 3. | Update F2 by F2 = F2 − S1 + S2 |
| | Sort the slices in list X by score in descending order | |
| | and append list X to list L and clear X | |
| Step 6 | If Q2 is smaller than a threshold M (9), then update P by: | |
| | | P = MIN(0, MAX(T3, 1 − F1/F2), where T3 is |
| | | set to 0.3125 |
| Step 7 | If one of the following conditions is true: | |
| | | F2 is smaller than target frame size |
| | | Q2 is larger than a threshold T2 (16) |
| | Go to step 8. | |
| | Otherwise increase Q2 by 1 and jump to step 3 | |
| Step 8 | Encode all slices in list L with quantization index Q2 | |
| Step 9 | Let R denote a slice to be replace. Initialize R to be | |
| | the first element in list L. | |
| | Initialize F2 to F1. | |
| Step 10 | Let CF denote the 1st pass compressed frame. Let S1 and | |
| | S2 denote the 1st pass and 2nd pass coded slice size of | |
| | slice R, respectively. If F2 − S1 + S2 < target frame | |
| | size, then do the following. | |
| | a. | Replace slice R in CF with the 2nd pass coded slice |
| | b. | Update F2 = F2 − S1 + S2 |
| | c. | Set R to be the next element in list L |
| | d. | Jump to step 10 |
| | Otherwise, do the following, | |
| | a. | Output CF as the final compressed frame |
| | b. | Start next frame from step 0 |

As shown above, this aspect utilizes the luma size slice statistics discussed above.

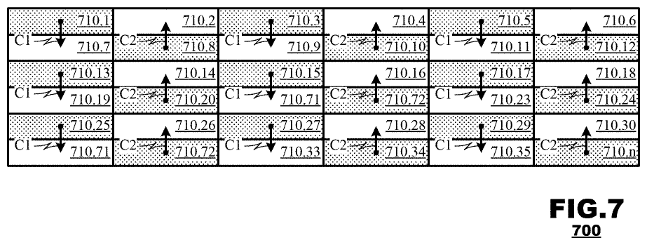

The principles of the present disclosure accommodate further embodiments. In application, the controller 240 (FIG. 2) need not develop statistics individually for every slice in an input frame. In an aspect, statistics for one slice in a frame may be derived from another slice in the frame that is spatially adjacent to it. FIG. 7 illustrates an exemplary implementation of this strategy. There, a frame 700 is shown as having been partitioned into slices 710.1-710.n. In this example, coding statistics may be computed for a first set of slices (in the example of FIG. 7, slices at alternating diagonal positions shown by shading). Coding statistics of the remaining slices (the slices at the remaining, unshaded diagonal positions) may be copied from adjacent slices in the first set. FIG. 7, for example, shows exemplary copying directions C1 and C2 provided at alternating slice positions, showing that statistics for slice 710.7 may be copied from those of slice 710.1 (direction C1) and statistics for slice 710.2 may be copied from those of slice 710.8 (direction C2). The direction of copying may be determined based on spatial relationships among the slice geometry.

In other aspects, the direction of copying may be determined dynamically based on image content, content motion, image gradients, or other video data that shows correlation between content of candidate slices. By copying statistics from one slice to the next, this aspect reduces computational resources that would be consumed to perform the methods of FIG. 4 or 6.

In another aspect, second pass coding may be skipped for slices whose quantization indices are lower than the initial quantization index that is set (boxes 415 (FIG. 4), 620 (FIG. 6)) prior to detection of coding artifacts. The early termination of slice decoding can reduce complexity and save power consumption within the controller 240 (FIG. 2).

The foregoing discussion has described operation of the embodiments of the present disclosure in the context of coding systems and decoding systems provided within terminals. Commonly, these components are provided as electronic devices. They can be embodied in integrated circuits, such as application specific integrated circuits, field programmable gate arrays and/or digital signal processors. Alternatively, they can be embodied in computer programs that are stored in memory and execute on processing devices of personal computers, notebook computers, computer servers or mobile computing platforms such as smartphones and tablet computers. Similarly, decoders can be embodied in integrated circuits, such as application specific integrated circuits, field programmable gate arrays and/or digital signal processors, or they can be embodied in computer programs that are stored in memory and execute on processing devices of personal computers, notebook computers, computer servers or mobile computing platforms such as smartphones and tablet computers. Decoders commonly are packaged in consumer electronics devices, such as gaming systems, DVD players, portable media players, tablet computers, smartphones, smartwatches, virtual reality goggles, augmented reality goggles, automotive media system, aircraft media systems and the like. They also can be packaged in consumer software applications such as video games, browser-based media players and the like. And, of course, these components may be provided as hybrid systems that distribute functionality across dedicated hardware components and programmed general purpose processors as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A coding method, comprising:
partitioning a frame of image data into pixel blocks;
coding the pixel blocks by a compression algorithm that includes transforming the pixel blocks into respective arrays of transform coefficients; and
estimating, from the transform coefficients of each block, a likelihood of coding artifacts created by coding of the respective pixel block.

2. The method of claim 1, wherein
the coding includes quantizing transform coefficients by parameters derived from a quantization index; and
the estimating comprises determining a highest frequency component of a non-zero quantized coefficient.

3. The method of claim 1, wherein
the coding includes quantizing transform coefficients by parameters derived from a quantization index and entropy coding the quantized coefficients; and
the estimating comprises determining a location of a last non-zero quantized coefficient according to a scanning direction of the entropy coding.

4. The method of claim 1, wherein
the pixel blocks are organized respectively into slices;
the coding includes quantizing pixel block transform coefficients by parameters derived from a quantization index and entropy coding the quantized coefficients, wherein a common quantization index is applied to all pixel blocks in a common slice; and
the estimating comprises determining a difference between a highest location of a last non-zero quantized coefficient and a lowest location of a last non-zero quantized coefficient among the pixel blocks in the common slice.

5. A coding method, comprising:
partitioning a frame of image data into slices and further into pixel blocks, wherein each pixel block is a member of a slice;
first coding the pixel blocks by a compression algorithm;
estimating a likelihood of coding artifacts in each slice created by the first coding of the slice's pixel blocks;
recoding the pixel blocks of slices estimated to have coding artifacts;
forming a final coded frame from first-coded pixel blocks of the slices that are not estimated to have coding artifacts and from recoded pixel blocks of the remaining slices.

6. The method of claim 5, wherein the coding comprises:
transforming the pixel blocks into respective arrays of transform coefficients,
quantizing transform coefficients by parameters derived from a quantization index, and
entropy coding the quantized coefficients; and
the estimating comprises, for at least one slice, determining a difference between a highest location of a last non-zero quantized coefficient and a lowest location of a last non-zero quantized coefficient among the pixel blocks in the common slice.

7. The method of claim 5, wherein the coding comprises:
coding a luma component of the pixel blocks,
the estimating comprises determining a coding size of the coded luma component data of all pixel blocks in a respective slice.

8. The method of claim 7, wherein the coding further comprises:
transforming the pixel blocks into respective arrays of transform coefficients,
quantizing transform coefficients by parameters derived from a quantization index that is common to all pixel blocks in a common slice, and
the estimating comprises determining the quantization index in a respective slice.

9. The method of claim 5, wherein the estimating comprises:
developing slice statistics from coded pixel block data;
in a first tier of analysis, estimating each slice's likelihood of coding artifacts by comparing the slice's statistics to first artifact criteria;
in a second tier of analysis, estimating each slice's likelihood of coding artifacts by:
determining whether the respective slice is a spatial neighbor to another slice previously estimated as likely to have coding artifacts, and
comparing the respective slice's statistics to second artifact criteria.

10. The method of claim 5, wherein the estimating comprises:
developing slice statistics from coded pixel block data;
for a first slice, estimating the slice's likelihood of coding artifacts by comparing the slice's statistics to artifact criteria; and
when the first slice is estimated as likely to have coding artifacts, estimating a second slice neighboring the first slice as likely to have coding artifacts.

11. A coding method, comprising:
partitioning a frame of image data into slices and further into pixel blocks, wherein each pixel block is a member of a slice;
first coding the pixel blocks by a compression algorithm;
estimating a likelihood of coding artifacts in each slice created by the first coding of the slice's pixel blocks;
recoding the pixel blocks of slices estimated to have coding artifacts;
forming a final coded frame from first-coded pixel blocks of the slices that are not estimated to have coding artifacts and from recoded pixel blocks of select other slices that are estimated to have coding artifacts, wherein the other slices are selected by:
prioritizing the slice based on their relative estimated likelihood of coding artifacts, in descending order of priority:
determining whether a size limit of the coded frame is exceeded by adding the recoded pixel blocks of the respective slice to the final coded frame, and
if the size limit is not exceeded, adding the recoded pixel blocks to the final coded frame.

12. The method of claim 11, further comprising, when if the size limit is exceeded, forming a remainder of the final coded frame first-pixel blocks of remaining slices.

13. The method of claim 11, wherein the coding comprises:
transforming the pixel blocks into respective arrays of transform coefficients,
quantizing transform coefficients by parameters derived from a quantization index, and
entropy coding the quantized coefficients; and
the estimating comprises determining a difference between a highest location of a last non-zero quantized coefficient and a lowest location of a last non-zero quantized coefficient among the pixel blocks in the common slice.

14. The method of claim 11, wherein the coding comprises:
coding a luma component of the pixel blocks
the estimating comprises determining a coding size of the coded luma component data of all pixel blocks in a respective slice.

15. A computer readable medium storing program instructions that, when executed by a processing device, cause the processing device to perform a coding method, comprising:
partitioning a frame of image data into pixel blocks;
coding the pixel blocks by a compression algorithm that includes transforming the pixel blocks into respective arrays of transform coefficients; and
estimating, from the transform coefficients of each block, a likelihood of coding artifacts created by coding of the respective pixel block.

16. The computer readable medium of claim 15, wherein
the coding includes quantizing the transform coefficients by parameters derived from a quantization index; and
the estimating identifies a highest frequency component of a non-zero quantized coefficient.

17. The computer readable medium of claim 15, wherein
the coding includes quantizing transform coefficients by parameters derived from a quantization index and entropy coding the quantized coefficients; and
the estimating identifies a location of a last non-zero quantized coefficient according to a scanning direction of the entropy coding.

18. The computer readable medium of claim 15, wherein
the pixel blocks are organized respectively into slices;
the coding includes quantizing pixel block transform coefficients by parameters derived from a quantization index and entropy coding the quantized coefficients, wherein a common quantization index is applied to all pixel blocks in a common slice; and
the estimating comprises determining a difference between a highest location of a last non-zero quantized coefficient and a lowest location of a last non-zero quantized coefficient among the pixel blocks in the common slice.

19. The computer readable medium of claim 15, wherein
the pixel blocks are organized respectively into slices;
the estimating identifies a likelihood of coding artifacts in each slice created by the first coding of the slice's pixel blocks;
the method further comprises:
recoding the pixel blocks of slices estimated to have coding artifacts;
forming a final coded frame from first-coded pixel blocks of the slices that are not estimated to have coding artifacts and from recoded pixel blocks of the remaining slices.

20. The computer readable medium of claim 15, wherein
the pixel blocks are organized respectively into slices,
the estimating indicates a likelihood of coding artifacts in each slice created by the coding of the slice's pixel blocks;
the method further comprising:
recoding the pixel blocks of slices estimated to have coding artifacts;
forming a final coded frame from first-coded pixel blocks of the slices that are not estimated to have coding artifacts and from recoded pixel blocks of select other slices that are estimated to have coding artifacts, wherein the other slices are selected by:
prioritizing the slice based on their relative estimated likelihood of coding artifacts,
in descending order of priority:
determining whether a size limit of the coded frame is exceeded by adding the recoded pixel blocks of the respective slice to the final coded frame, and
if the size limit is not exceeded, adding the recoded pixel blocks to the final coded frame.

21. The computer readable medium of claim 20, further comprising, when if the size limit is exceeded, forming a remainder of the final coded frame first-pixel blocks of remaining slices.

22. The computer readable medium of claim 15, wherein
the pixel blocks are organized respectively into slices,
the coding further comprises coding a luma component of the pixel blocks, and
the estimating further comprises determining a coding size of the coded luma component data of all pixel blocks in a respective slice.

23. The computer readable medium of claim 15, wherein
the pixel blocks are organized respectively into slices,
the estimating:
in a first tier of analysis, indicates each slice's likelihood of coding artifacts by comparing the slice's statistics to first artifact criteria;
in a second tier of analysis, indicates each slice's likelihood of coding artifacts by:
determining whether the respective slice is a spatial neighbor to another slice previously estimated as likely to have coding artifacts, and
comparing the respective slice's statistics to second artifact criteria.

24. The computer readable medium of claim 15, wherein
the pixel blocks are organized respectively into slices,
for a first slice, the estimating indicates the slice's likelihood of coding artifacts by comparing the slice's statistics to artifact criteria; and
when the first slice is estimated as likely to have coding artifacts, the estimating indicates a second slice neighboring the first slice is likely to have coding artifacts.

25. A video coder, comprising:
a partitioning unit having an input for a frame of image data and an output for pixel blocks obtained therefrom;
a pixel block coder that codes the pixel blocks by a compression algorithm that includes transforming the pixel blocks into respective arrays of transform coefficients; and
a controller that estimates, from the transform coefficients of each block, a likelihood of coding artifacts created by coding of the respective pixel block.
